(19) United States
(12) Patent Application Publication
(10) Pub. No.: US 2026/0216715 A1
(43) Pub. Date: Jul. 30, 2026

(54) CATALYSTS INCLUDING BORONIC, METAL HYDROXIDE, OR METAL OXIDE ACTIVE-SITE GROUPS

(71) Applicant: 1s1 Energy, Inc., Portola Valley, CA (US)

(72) Inventors: Sukanta Bhattacharyya, Belmont, CA (US); Daniel Sobek, Portola Valley, CA (US)

(21) Appl. No.: 19/159,101

(22) PCT Filed: Jun. 23, 2023
(86) PCT No.: PCT/US2023/026114

§ 371 Date: Aug. 22, 2025

Related U.S. Application Data
(60) Provisional application No. 63/448,016, filed on Feb. 24, 2023.

(51) Int. Cl. B01J 31/22; B01J 23/18; B01J 23/42; B01J 23/46; B01J 23/644; B01J 35/33; B01J 37/04; C01C 1/04; C25B 1/27; C25B 9/19; C25B 11/048; H01M 4/90; H01M 4/92; H01M 8/10; H01M 8/1004

(52) U.S. Cl. CPC B01J 31/2213; B01J 23/18; B01J 23/42; B01J 23/468; B01J 23/6447; B01J 35/33; B01J 37/04; C01C 1/0411; C25B 1/27; C25B 9/19; C25B 11/048; H01M 4/9008; H01M 4/9016; H01M 4/923; H01M 8/1004; B01J 2531/54; B01J 2531/827; B01J 2531/828; H01M 2008/1095

(57) ABSTRACT

A catalyst includes a catalyst particle including a first metal atom and an active-site group linked to the first metal atom by one or more oxo-bridges. The active-site group includes a boronic group, a metal hydroxide group, or a metal oxide group. The metal hydroxide group includes a second metal atom or beryllium and the metal oxide group includes the second metal atom. The second metal atom is different from the first metal atom and includes aluminum, gallium, indium, or bismuth.

### RELATED APPLICATIONS

The present application claims priority to U.S. Provisional Patent Application No. 63/448,016, filed Feb. 24, 2023, which is hereby incorporated by reference in its entirety.

### BACKGROUND INFORMATION

In some electrochemical cells, such as hydrogen fuel cells and water electrolysis systems, proton exchange membranes (PEMs) are used to selectively transport protons. PEMs are semipermeable membranes that transport protons (H⁺) while being impermeable to gases. PEMs are generally composed of a porous framework with highly acidic functional groups. For example, polyfluorosulfonic acid-based PEMs contain a poly(tetrafluoroethylene) (PTFE) porous framework with sulfonic acid groups. The easily dissociable sulfonic acid groups serve as proton transport agents in the membrane. In hydrogen fuel cells, hydrogen gas (H₂) separates at the anode into protons (H⁺) and electrons. The protons pass through a PEM and combine with oxygen gas (O₂) at a cathode to produce water while the electrons flow through an external circuit to produce electricity. In water electrolysis systems, electricity splits water at the anode into oxygen gas (O₂) and protons (H⁺). The protons pass through the PEM and combine with electrons at the cathode to produce hydrogen gas (H₂).

A membrane electrode assembly (MEA) may include a PEM positioned between a first catalyst layer and a second catalyst layer. The catalyst layers are electrically conductive electrodes (anode and cathode) with embedded electrochemical catalyst particles such as metals, metal alloys, or metal oxides. The catalyst particles may be supported on a catalyst solid support, which generally includes an electrically conductive, high surface-area carbon (e.g., graphite or graphene). The electrochemical catalysts reduce the activation energy needed to carry out electrochemical reactions at the electrodes, such as the oxygen evolution reaction (OER) and the hydrogen evolution reaction (HER) in water electrolysis applications and the hydrogen oxidation reaction (HOR) and the oxygen reduction reaction (ORR) in fuel cell applications.

In water electrolysis, the OER is represented by the following electrochemical half-reaction (equation (1)):

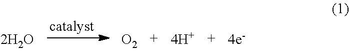

The OER mechanism is a complex, multi-step electrochemical process involving the transfer of four electrons, wherein a metal oxide catalyst binds reversibly with oxygenated intermediates. A proposed OER mechanism proceeds in the following four steps given by reaction equations (1a) to (1d):

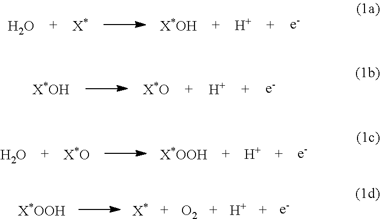

where X* represents the catalyst, the asterisk (*) represents the active site of the catalyst, and X*OH, X*O, and X*OOH represent intermediate species bound to the catalyst active site.

As shown in reaction equation (1a), the first step in the OER is a hydroxylation step in which water molecules dissociate into protons (H⁺) and hydroxide ions (OH⁻) and the hydroxide ions reversibly bind with the active sites of the anodic catalyst. This binding may happen directly to the metal atoms as well as at the oxygenated centers through the involvement of the lattice oxygen atoms presented on the metal oxide catalyst surfaces (lattice oxygen participation). The subsequent steps of the OER (reaction equations (1b), (1c), and (1d)) involve multiple steps of electron transfer and oxidation, after which oxygen gas (02) is released at the anode and the active catalyst sites are freed for the next catalytic cycle. The hydroxylation step (1a) is often the rate-limiting step for the OER.

Iridium(IV) oxide (IrO₂) and its various surface-hydroxylated compositions are currently used as catalysts of choice for the OER at the anode in water electrolysis, as well as in other applications, due to their superior performance, energy efficiency, and high stability under a broad pH range. Iridium(IV) oxide may also be used in conjunction with ruthenium oxide (ruthenium(IV) oxide (RuO₂)) or other platinum group metals for enhanced performance. However, platinum group metals, including iridium and ruthenium, are expensive and have low natural abundances. Accordingly, there is a need for catalysts with lower iridium and/or ruthenium loading and/or that use non-platinum group metals while providing optimal reversible binding with substrates, stability under harsh redox conditions, fast kinetics, and low energy loss during electrochemical processes.

### SUMMARY

The following description presents a simplified summary of one or more aspects of the apparatuses, compositions, and/or methods described herein in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects of the apparatuses, compositions, and/or methods described herein in a simplified form as a prelude to the more detailed description that is presented below.

In some illustrative examples, a catalyst comprises: a catalyst particle comprising a first metal atom and an active-site group linked to the first metal atom by one or more oxo-bridges, wherein: the active-site group comprises a boronic group, a metal hydroxide group, or a metal oxide group; the metal hydroxide group comprises a second metal atom or beryllium; the metal oxide group comprises the second metal atom; and the second metal atom is different from the first metal atom and comprises aluminum, gallium, indium, or bismuth.

In some illustrative examples, a catalyst comprises: a first metal atom; and an active-site group comprising a boron atom or a second metal atom, wherein: the boron atom or the second metal atom is linked to the first metal atom by one or more oxo-bridges; and the second metal atom is different from the first metal atom and comprises aluminum, gallium, indium, bismuth, or beryllium.

In some illustrative examples, a method of making a catalyst comprises: modifying a catalyst particle comprising a first metal atom with an active site group, wherein: the active-site group comprises a boronic group, a metal hydroxide group, or a metal oxide group; the metal hydroxide group comprises a second metal atom or beryllium; the metal oxide group comprises the second metal atom; and the second metal atom is different from the first metal atom and comprises aluminum, gallium, indium, or bismuth.

In some illustrative examples, a method comprises carrying out the oxygen evolution reaction (OER) represented by the following electrochemical half-reaction of reaction equation (1) using any catalyst described herein:

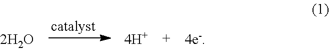

In some illustrative examples, a method comprises carrying out the oxygen reduction reaction (ORR) represented by the electrochemical half-reaction of reaction equation (2) using any catalyst described herein:

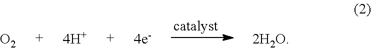

In some illustrative examples, a catalyst layer comprises: a catalyst support; any catalyst described herein; and an ionomer.

In some illustrative examples, a membrane electrode assembly comprises: a cathode; an anode; and a proton exchange membrane positioned between the cathode and the anode; wherein at least one of the cathode or the anode comprises a catalyst layer comprising: a catalyst support; and any catalyst described herein.

In some illustrative examples, a method of producing ammonia comprises combining nitrogen and hydrogen according to reaction equation (3) using any catalyst described herein:

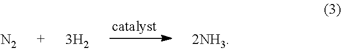

### BRIEF DESCRIPTION OF THE DRAWINGS

To aid in understanding the concepts described herein, various embodiments will be described by way of example only, with reference to the drawings. The drawings illustrate various embodiments and are a part of the specification. The illustrated embodiments are merely examples and do not limit the scope of the disclosure. Throughout the drawings, identical or similar reference numbers designate identical or similar elements.

FIGS. 1A-1C show illustrative reaction schemes for producing a boronic group-modified iridium(IV) oxide catalyst.

FIGS. 2A-2C show illustrative reaction schemes for producing a bismuth hydroxide group-modified iridium(IV) oxide catalyst.

FIG. 3 shows an illustrative reaction scheme for producing an iridium(IV) oxide catalyst material modified with a boronic group and a bismuth hydroxide group.

FIGS. 4A and 4B show illustrative reaction schemes for producing a catalyst based on bismuth(III) oxide (Bi₂O₃).

FIGS. 5A-5C show illustrative reaction schemes for producing a boronic group-modified iridium(IV) catalyst using iridium(III) chloride.

FIGS. 6A-6C show illustrative reaction schemes for producing a bismuth hydroxide group-modified iridium(IV) catalyst using iridium(III) chloride.

FIG. 7 shows an illustrative proton exchange membrane water electrolysis system.

FIG. 8 shows an illustrative proton exchange membrane fuel cell.

### DETAILED DESCRIPTION

As described herein, a catalyst includes a catalyst particle that includes a first metal atom M¹ and an active-site group linked to the first metal atom M¹ by one or more oxo-bridges. The active-site group may be a boronic group, a metal hydroxide group, or a metal oxide group. A metal hydroxide group includes a second metal atom (M²) or beryllium, and a metal oxide group includes the second metal atom M². The second metal atom M² is different from the first metal atom M¹ and may be aluminum, gallium, indium, or bismuth. In some examples, the first metal atom M¹ is a transition metal (e.g., nickel, cobalt, or iron). In other examples, the first metal atom M¹ is a platinum group metal (e.g., iridium or ruthenium). In further examples, the first metal atom M¹ is bismuth. The boron atom of the boronic group and/or the second metal atom M² of the metal hydroxide group or metal oxide group is linked to the first metal atom M¹ by one or two oxo-bridges. The boron atom of the boronic group and the second metal atom M² of the metal hydroxide group or metal oxide group are electron deficient and thus readily bind hydroxide ions and other reactive intermediates and relay the hydroxide ions and intermediates to neighboring metal atoms (e.g., first metal atoms M¹) and/or oxygen atoms (e.g., lattice oxygen atoms). Thus, the boron atom and the second metal atom M² act as gateways to catalyst substrate binding.

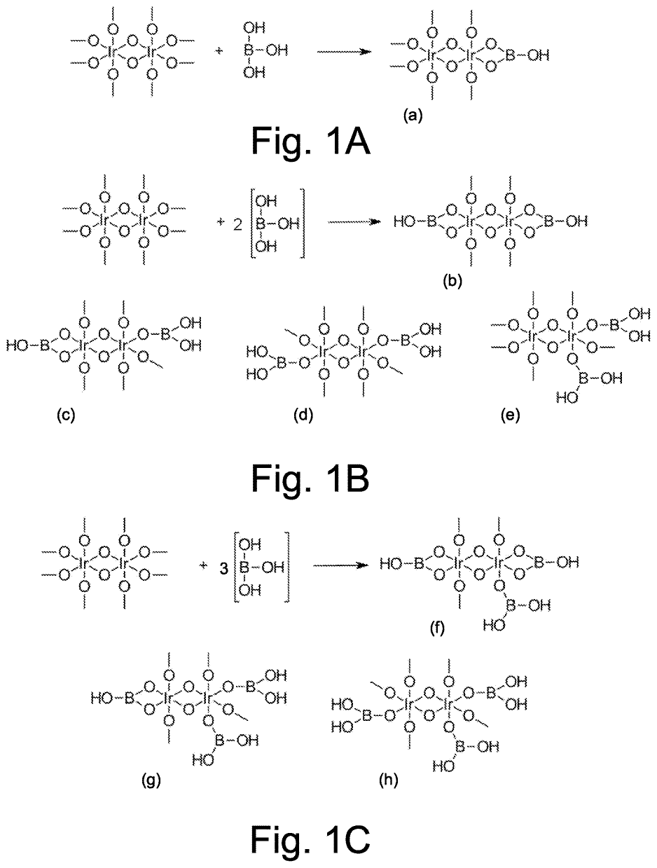

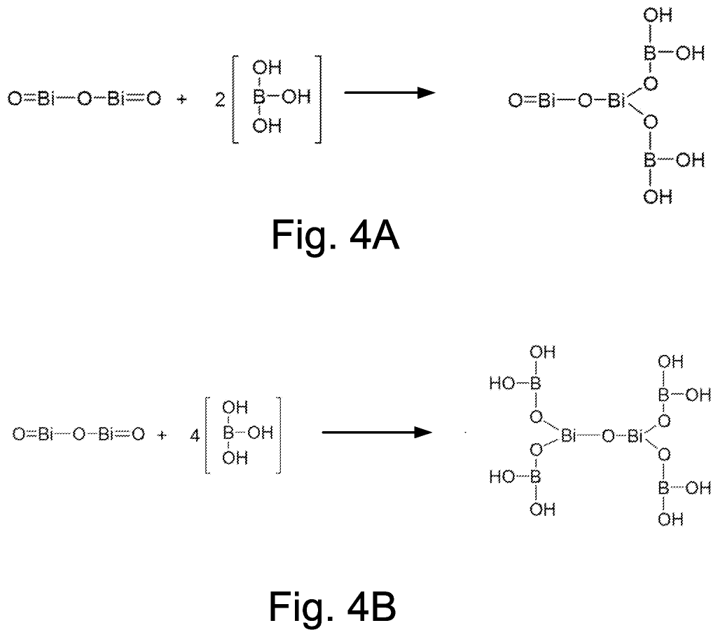

For example, in the hydroxylation step (1a) of the OER, the boron atom of the boronic group or the second metal atom M² of the metal hydroxide group or metal oxide group accepts hydroxide anion binding seamlessly and rapidly. The rapid binding of the hydroxide ions with the boron atom and/or the second metal atom M² results in faster kinetics and lowers the overpotential for the OER as compared with conventional electrocatalysts. Additionally, the catalysts described herein efficiently bind with the OER intermediate species not too strongly and not too weakly. Moreover, the catalysts described herein have efficient catalyst throughput in the OER due to the high catalyst stability under the harsh redox conditions of water electrolysis, faster kinetics, and low energy loss during the electrochemical processes. As a result, the catalysts described herein have intrinsic molecular properties that allow a decreased platinum group metal loading (as in the examples of FIGS. 1A to 1C, 2A to 2C, 3, 5A to 5C, and 6A to 6C) or eliminate the use of platinum group metals altogether (as in the examples of FIGS. 4A and 4B).

The catalysts described herein may also be used in other electrochemical reactions in addition to the OER (e.g., the ORR, HER, or HOR) as well as in other non-electrochemical applications, such as the Haber-Bosch process for the production of ammonia. Illustrative uses and applications of the catalysts will be described below in more detail.

Various definitions will now be provided to aid in understanding various aspects of the present disclosure. In case of conflict with any patent application publication or patent incorporated herein by reference, the present specification, including definitions, will control.

As used herein, a “catalyst particle” refers to a particle in “black” or pure form (e.g., exclusive of any catalyst support to which the catalyst particle may be bound and exclusive of any catalyst additives) that increases the rate of a reaction without modifying the overall standard Gibbs free energy change in the reaction. A catalyst particle may be an individual molecule (including but not limited to a monomer molecule), a group of molecules, a crystal structure (e.g., as in a metal oxide), a polymer molecule, or an oligomer molecule. A catalyst particle may have any suitable size and shape, such as a microparticle, a nanoparticle, or a nanotube. A catalyst particle may include, for example, a metal, a metal alloy, a metal oxide, a metal halide (e.g., a metal chloride), or a composite including at least one of a metal, a metal alloy, a metal oxide, or a metal halide.

As used herein, an “electrocatalyst particle” or “electrochemical catalyst particle” refers to a catalyst particle that reduces the activation energy needed to carry out electrochemical reactions and/or increases the rate of electrochemical reactions, such as the OER, HER, HOR, and/or ORR. Suitable electrocatalyst particles may include, without limitation, metals such as platinum group metals (PGMs) (e.g., platinum, palladium, iridium, ruthenium, osmium, and rhodium), transition metals (e.g., silver, gold, cobalt, copper, iron, nickel, rhenium, and mercury), and post-transition metals (e.g., bismuth and tin), metal alloys (e.g., PGM-transition metal based alloys and platinum-ruthenium based alloys), metal oxides (e.g., PGM oxides, such as iridium(IV) oxide, ruthenium(IV) oxide, iridium ruthenium oxide, platinum(IV) oxide, magnesium oxide, and cerium(IV) oxide), metal halides (e.g., platinum(IV) chloride, iridium(III) chloride, platinum(IV) bromide, iridium(III) bromide), and/or composites of metals, metal alloys, metal oxides, and/or metal halides.

As used herein, a “catalyst support” refers to a substance, exclusive of a catalyst particle, that may be used to support catalyst particles (e.g., a substance or material to which catalyst particles may be bound or on which catalyst particles may be supported). Examples of catalyst supports include, without limitation, carbon (e.g., graphite, carbon nanotubes, and/or graphene), titanium dioxide, Sb-doped SnO₂ nanoparticles, tin-doped indium oxide (ITO), and/or the ion exchange-modified catalyst supports described in International Patent Application No. PCT/US2022/046105, filed Oct. 7, 2022, the contents of which are incorporated herein by reference in their entirety.

As used herein, a “catalyst” refers to a catalyst particle as well as a catalyst particle together with a catalyst support on which the catalyst particle is supported or to which the catalyst particle is bound. A catalyst may also include catalyst additives, such as promoters (such as, but not limited to, metalloids).

As used herein, an “electrocatalyst” or “electrochemical catalyst” refers to an electrocatalyst particle in “black” or pure form as well as an electrocatalyst particle together with a catalyst support on which the electrocatalyst particle is supported or to which the catalyst particle is bound. An electrocatalyst may also include catalyst additives, such as promoters.

As used herein, “metal” includes alkali metals, alkaline earth metals, transition metals, lanthanides, actinides, and post-transition metals.

As used herein, “transition metals” refers to elements of the d-block of the periodic table (Groups 3 to 12, inclusive).

As used herein, “post-transition metals” refers to aluminum, gallium, indium, tin, thallium, lead, bismuth, and polonium.

As used herein, “metalloids” refers to boron, silicon, germanium, arsenic, antimony, tellurium, and astatine.

As used herein, “platinum group metals” or “PGMs” refers to platinum, palladium, iridium, ruthenium, osmium, and rhodium.

As used herein, a “composite” means a material having a combination of two or more distinct constituent materials, each of which retains its own distinctive properties, but which has properties that the constituent materials do not have acting alone.

As used herein, an “ionomer” refers to a polymer composed of macromolecules in which a small but significant proportion (e.g., about 15 mol % or less) of the constitutional units have ionic and/or ionizable groups (e.g., a sulfonic acid group, a carboxylic acid group, a phosphoric acid group, a tetravalent boron-based acid group, etc.).

As used herein, the term “alkyl” refers to saturated aliphatic groups, including straight-chain alkyl groups, branched-chain alkyl groups, cycloalkyl (alicyclic) groups, alkyl substituted cycloalkyl groups, and cycloalkyl substituted alkyl groups. The term “alkyl” and the like encompasses both substituted and unsubstituted groups. Examples of non-cycloalkyl groups include, but are not limited to, methyl, ethyl, propyl, isopropyl, butyl, isobutyl, n-butyl, tert-butyl, n-pentyl, neopentyl, n-hexyl, n-heptyl, n-octyl, n-decyl, n-undecyl, and dodecyl. Examples of cyclic alkyl groups include, but are not limited to, cyclopropyl, cyclobutyl, and cyclochexyl.

The term “aryl” refers to aromatic carbocyclic groups having a single ring (e.g., phenyl), multiple rings (e.g., biphenyl), or multiple fused rings, in which at least one ring is aromatic (e.g., 1,2,3,4-tetrahydronaphthyl, naphthyl, anthryl, or phenanthryl). For example, at least one ring may have a conjugated Pi electron system, while other, adjoining rings can be cycloalkyls, cycloalkenyls, cycloalkynyls, aryls, and/or heterocycyls. “Carbocyclic aryl groups” refer to aryl groups wherein the ring atoms on the aromatic ring are carbon atoms. Carbocyclic aryl groups include monocyclic carbocyclic aryl groups and polycyclic or fused compounds (e.g., two or more adjacent ring atoms are common to two adjoining rings) such as naphthyl group. The term “aryl” and the like encompasses both substituted and unsubstituted groups. Examples of aryl groups include, without limitation, phenyl, naphthyl, tetrahydronaphthyl, indanyl, and indenyl.

The term “alkoxyl” or “alkoxy” refers to an alkyl group having an oxygen radical attached thereto, and has the general formula R—O where R is an alkyl group. Examples of alkoxyl groups include, without limitation, methoxy, ethoxy, propyloxy, and tert-butoxy groups.

The term “aryloxy” refers to an aryl group having an oxygen radical attached thereto and has the general formula Ar—O where Ar is an aryl group. An example of an alkoxyl group includes, without limitation, a phenoxy group.

The term “oxo bridge” refers to a bridging oxo ligand (O²⁻) that binds two metal centers or that binds boron with a metal center.

Illustrative catalysts will now be described. A catalyst includes a catalyst particle and may optionally include other components, such as a catalyst support and/or additives (e.g., promoters). The catalyst particle is a metal complex and includes a first metal atom M¹ and an active-site group linked to the first metal atom M¹ by one or more oxo-bridges. The first metal atom M¹ is a metal center of the catalyst particle and may be, by way of non-limiting examples, a transition metal (e.g., nickel, cobalt, iron), a platinum group metal, or bismuth. The active-site group includes a boronic group, a metal hydroxide group, or a metal oxide group. The metal hydroxide group includes a second metal atom M² or beryllium (Be), and the metal oxide group includes the second metal atom M². The second metal atom M² is different from the first metal atom M¹ and may be aluminum, gallium, indium, or bismuth. The catalyst particle is a mono-metallic (where the active-site group includes a boronic group), bi-metallic, or tri-metallic complex with one or more active-site groups oxo-bridged with one or more metal centers. The catalyst particle may be formed by an initial bond between a hydroxyl group of an active-site reagent (e.g., a boronic compound (e.g., boric acid, a boronic acid, a boronic ester), a mixture of diboron trioxide and water, a metal hydroxide, or a metal oxyhydroxide) with the first metal atom M¹ of a metal oxide catalyst particle, followed by a proton transfer from the bound hydroxyl group to an lattice oxygen atom of the metal oxide catalyst particle. Alternatively, the catalyst particle may be formed directly by a substitution reaction involving an active-site reagent with a metal chloride catalyst particle in the presence of water and oxygen. Illustrative examples of reaction schemes for forming catalysts will be described below in more detail.

In some examples, the catalyst particle comprises a metal oxide catalyst particle and an active-site group oxo-bridged to the first metal atom M¹ at a surface of the metal oxide catalyst particle. A metal oxide catalyst particle includes cations of at least one metal ionically bonded to oxide (O²⁻) anions. Metal oxides include single-metal oxides (also referred to as simple oxides) and mixed-metal oxides (also referred to as complex oxides). A single-metal oxide includes cations of a single metal in a single state of oxidation. Mixed-metal oxides include cations of a metal and one or more other elements (e.g., another metal or a non-metal). Mixed-metal oxides also encompass materials having cations of a single metal in several different states of oxidation.

Illustrative examples of metal oxides constituting the catalyst particle include, without limitation, iridium(IV) oxide (IrO₂), ruthenium(IV) oxide (RuO₂), platinum(IV) oxide (PtO₂), palladium(II) oxide (PdO), osmium dioxide (OsO₂), osmium(VIII) oxide (OsO₄), rhodium oxide (RhO₂), bismuth(III) oxide (Bi₂O₃), nickel(II) oxide (NiO), cobalt(II) oxide (CoO), cobalt(II,III) oxide (Co₃O₄), lead oxide (PbO₂), iron oxide (e.g., iron(II,III) oxide (Fe₃O₄)), nickel iron oxide (NiFeOₓ) (e.g., Ni(Fe)O(OH), FeO(OH)NiO(OH), Ni₁₋ₓFeₓ(OH)₂/Ni₁₋ₓFeₓO(OH)), manganese oxide (MnOₓ) (e.g., manganese(II) oxide (MnO), manganese(II,III) oxide (Mn₃O₄), manganese(II) oxide (Mn₂O₃), manganese dioxide (MnO₂), manganese(VI) oxide (MnO₃), manganese(VII) oxide (Mn₂O₇)), ruthenium iridium oxide (RuIrO₂), ruthenium tantalum oxide (RuTaO₂), platinum ruthenium oxide (PtRuO₂), ruthenium cobalt oxide (RuCo₃O₂), ruthenium tin oxide (RuSnO), iridium tin oxide (IrSnO₂), ruthenium iridium tantalum oxide, ruthenium titanium tin oxide, iridium titanium platinum oxide, lanthanum nickel oxide (LaNiO₃), lanthanum cobalt oxide (LaCoO₃), strontium cobalt oxide (SrCoO₃), and strontium nickel oxide (SrNiO₃).

Metal oxides exist in a variety of crystal structures and polymorphs. Some metal oxides, including transition metal oxides such as iridium(IV) oxide and ruthenium(IV) oxide, generally have a rutile-like structure, although some metal oxides may have other structures, such as perovskite, spinel, or amorphous. Metal oxides may be doped (e.g., with tin, cobalt, nickel, and/or fluorine) and/or include impurities and/or defects. Metal oxides may be hydroxylated at the surface, typically when in the presence of water or water vapor or due to aqueous reaction conditions during synthesis of the metal oxide.

In other examples, the catalyst particle is a single molecule (e.g., a monomer), a group of molecules (e.g., to form a nanoparticle), a polymer, or an oligomer. In some examples, these catalyst particles are derived from a metal halide (e.g., a metal chloride) comprising the first metal atom M¹. The metal halide undergoes a substitution reaction with an active-site reagent (e.g., a boronic compound, a mixture of diboron trioxide and water, a metal hydroxide, or a metal oxyhydroxide) comprising the second metal atom M² to substitute the halo group with an active-site group. Illustrative examples of reaction schemes for producing a catalyst using a metal halide will be described below in more detail.

The boronic group of the catalyst particle comprises a trivalent boron (B) atom oxo-bridged with the first metal atom M¹ by one or two oxo-bridges. In some examples, the boronic group includes the structures (Ia) and (Ib):

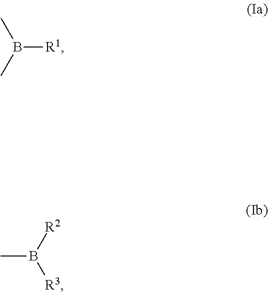

wherein the open bonds with boron are part of the oxo-bridges and R¹, R², and R³ are the same or different and each is independently a hydroxyl group (OH), an alkyl group, an aryl group, an alkoxy group, or an aryloxy group. In some examples, the alkyl group has one to twenty carbon atoms. In other examples, the alkyl group has one to ten carbon atoms. In yet further examples, the alkyl group has one to five carbon atoms. In some examples, the aryl group has one to twenty carbon atoms. In other examples, the aryl group has one to ten carbon atoms. In yet further examples, the aryl group has one to five carbon atoms. In some examples, the alkoxy group has the general formula —O—R⁴ where O is bonded to the boron atom of (Ia) or (Ib) and R⁴ is an alkyl group having one to ten carbon atoms, one to five carbon atoms, or one to three carbon atoms (e.g., a methyl group, an ethyl group, a propyl group, or an isopropyl group).

Boron is a p-block element with three electrons (2s², 2p¹) in its outermost orbit. The trivalent boron atoms in the boronic group are sp²-hybridized and possess an empty p-orbital and thus remain electron deficient (e.g., two electrons short of a stable octet electronic configuration). As a result, the boron atoms seamlessly and rapidly accept hydroxide anion binding, becoming the gateway for the hydroxylation step (reaction equation (1a)) of the OER. Furthermore, the rapid binding of the hydroxide ions with the boron atoms results in faster kinetics and lowers the overpotential for the OER as compared with conventional electrocatalysts. After the hydroxylation step, the bound hydroxide ions are transferred or relayed from the boron atom to neighboring first metal M¹ centers (e.g., iridium) and/or oxygen atoms of the catalyst particle for the subsequent steps of the OER (e.g., reaction equations (1b) to (1d)). Once the boron active sites are opened up, they are available for the next catalytic cycle and can bind again with hydroxide ions from water dissociation.

The increased number of oxygen atoms provided by the boronic groups also provides a cooperative ambience for hydroxide ion binding through lattice oxygen participation. Moreover, the boronic group-modified catalysts are highly stable at both low pH and high pH and facilitate the OER under acidic conditions using proton exchange membranes (PEMs) and under alkaline conditions using anion exchange membranes (AEMs).

A metal hydroxide group is formed by the reaction of one or two hydroxyl groups of a metal hydroxide having the formula M²(OH)₃ or Be(OH)₂ with the first metal atom M¹ of the catalyst particle, wherein M² is the second metal atom of the catalyst particle and is aluminum (Al), gallium (Ga), indium (In), or bismuth (Bi), and Be is beryllium. A metal oxide group is formed by the reaction of a hydroxyl group of a metal oxyhydroxide having the formula M²O(OH) with the first metal atom M¹ of the catalyst particle. The metal hydroxide group comprises an aluminum hydroxide group, a gallium hydroxide group, an indium hydroxide group, a bismuth hydroxide group, or a beryllium hydroxide group. The metal oxide group comprises an aluminum oxide group, a gallium oxide group, an indium oxide group, or a bismuth oxide group. As used herein, “metal hydroxide/oxide group” is an umbrella term that refers to a metal hydroxide group as well as a metal oxide group. A metal hydroxide/oxide group includes the second metal atom M² or beryllium oxo-bridged with the first metal atom M¹ of the catalyst particle by one or two oxo-bridges and one or two pendant hydroxyl groups (derived from a metal hydroxide) or a pendant oxo group (derived from a metal oxyhydroxide). A metal hydroxide group includes the structures (IIa), (IIb), and (IIc) shown below:

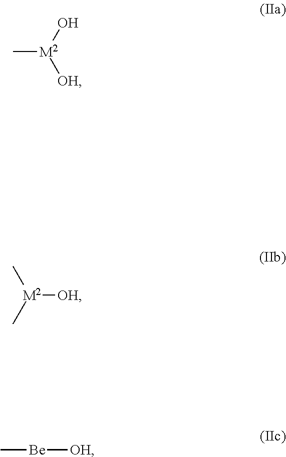

wherein the open bonds are part of the oxo-bridges, M² is the second metal atom and is aluminum (Al), gallium (Ga), indium (In), or bismuth (Bi), and Be is beryllium. A metal oxide group includes the structure (IId) shown below:

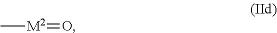

wherein the open bond with M² is part of the oxo-bridge and M² is the second metal atom, as set forth above.

Similar to boron atoms of the boronic group-modified catalyst particles, metal atoms of the metal hydroxide/oxide group (e.g., second metal atom M² and beryllium) are electron-deficient and thus seamlessly and rapidly accept hydroxide anion binding, thus becoming gateways for the hydroxylation step (reaction equation (1a)) of the OER. The rapid binding of the hydroxide ions with second metal atoms M² of the metal hydroxide/oxide group results in faster kinetics and lowers the overpotential for the OER as compared with conventional electrocatalysts. After the hydroxylation step (1a), the bound hydroxide ions are transferred or relayed from second metal atoms M² to neighboring metal centers (e.g., first metal atoms M¹) and/or oxygen atoms of the catalyst particle for the subsequent steps of the OER (e.g., reaction equations (1b) to (1d)). Once the metal active sites of the metal hydroxide/oxide groups are opened up, the second metal atoms M² of the active-site groups are available for the next catalytic cycle and can bind again with hydroxide ions from water dissociation.

The increased number of oxygen atoms provided by the metal hydroxide/oxide groups and oxo-bridges also provides a cooperative ambience for hydroxide ion binding through lattice oxygen participation. Moreover, the metal hydroxide/oxide group-modified catalyst particles are highly stable at both low pH and high pH and facilitate the OER under acidic conditions using proton exchange membranes (PEMs) and under alkaline conditions using anion exchange membranes (AEMs).

The catalyst particle may have any suitable degree of modification with active-site groups. In some examples, the catalyst particle includes two or more different active-site groups (e.g., boronic groups, metal hydroxide groups, and/or metal oxide groups).

Due to the oxo-bridged boron atoms and/or oxo-bridged second metal atoms M² of the active-site groups, which play important gateway roles in catalyst substrate binding followed by relaying the substrate to the first metal atoms M¹, the catalysts are more potent than conventional electrocatalysts to form the initial complex with reactive intermediates (e.g., OH) of redox reactions. Moreover, the hydroxylated environment around the surface of the catalysts helps keep the catalysts active and stable, thus minimizing platinum group metal loading.

The catalysts described herein may be synthesized in any suitable way. In some examples, a metal oxide catalyst particle or a metal halide catalyst particle is combined with an active-site reagent. The active-site reagent reacts with the metal oxide catalyst particle or the metal halide particle to modify the metal oxide catalyst particle or the metal halide catalyst particle with an active-site group. The active-site reagent may be a boronic compound, a mixture of diboron trioxide (B₂O₃) and water (which react to form boric acid), a metal hydroxide (e.g., M²(OH)₃ or Be(OH)₂), and/or a metal oxyhydroxide (e.g., M²O(OH)).

A boronic compound includes, for example, boric acid (B(OH)₃), a boronic acid, or a boronic ester. A boronic acid has the general formula B(OH)(R⁵)(R⁶) where R⁵ is a hydroxyl group, an alkyl group, or an aryl group and R⁶ is an alkyl group or an aryl group. In some examples, R⁵ and/or R⁶ have one to twenty carbon atoms. In other examples, R⁵ and/or R⁶ have one to ten carbon atoms. In further examples, R⁵ and/or R⁶ have one to five carbon atoms. A boronic ester has the general formula B(OH)(R⁷)(R⁸) where R⁷ is a hydroxyl group, an alkoxy group, or an aryloxy group and R⁸ is an alkoxy group or an aryloxy group. In some examples, R⁷ and/or R⁸ have one to ten carbon atoms. In other examples, R⁷ and/or R⁸ have one to five carbon atoms. In further examples, R⁷ and/or R⁸ have one to three carbon atoms (e.g., a methyl group, an ethyl group, a propyl group, or an isopropyl group).

Metal hydroxides include aluminum(III) hydroxide (Al(OH)₃), gallium(III) hydroxide (Ga(OH)₃), indium(III) hydroxide (In(OH)₃), bismuth(III) hydroxide (Bi(OH)₃), and beryllium(II) hydroxide (Be(OH)₂). Metal oxyhydroxides include aluminum(III) oxyhydroxide (AIO(OH)), gallium(III) oxyhydroxide (GaO(OH)), indium(III) oxyhydroxide (InO(OH)), and bismuth(III) oxyhydroxide (BiO(OH)).

In some examples, the catalyst particle and the active-site reagent are combined in a solvent. Suitable solvents may include, without limitation, water as well as mixed aqueous solvents including water and dimethylacetamide (DMA), dimethylformamide (DMF), N-methylpyrrolidone (NMP), and/or a glyme solvent. Glyme solvents include, for example, monoglyme (dimethoxyethane), diglyme (bis(2-methoxyethyl) ether), triglyme, tetraglyme, ethyl glyme, ethyl diglyme, butyl glyme, butyl diglyme, pentaglyme, hexaglyme, polyglyme, dipropylene glycol dimethyl ether, and dipropylene glycol dimethyl ether (P2). In further examples, the reaction is carried out under solvent-less dry conditions using mechanochemical mixing (e.g., ball milling). In some examples, the reaction is carried out by directly reacting a metal oxide catalyst particle (e.g., iridium(IV) oxide or platinum(IV) oxide) or a metal halide catalyst particle (e.g., iridium chloride or platinum chloride) with an active-site reagent. In some examples, the reaction is carried out at a temperature ranging from ambient (e.g., approximately 25° C.) to approximately 120° C. In some examples, the reagents are mixed using mechanical agitation and/or sonication (e.g., ultrasonication).

As mentioned, in some examples the reaction comprises combining a metal oxide catalyst particle with an active-site reagent. In these reactions, the metal oxide catalyst particle is modified at the surface by a surface modification reaction. The reaction mechanism includes one or two hydroxyl groups of the active-site reagent linking with a first metal atom M¹ of the metal oxide catalyst particle at the surface of the catalyst particle, followed by a proton transfer from the hydroxyl group(s) to a neighboring lattice oxygen atom. The molar ratio of the active-site reagent to the metal oxide catalyst particles may be tuned for desired catalyst performance while minimizing metal (e.g., platinum group metal) loading.

In other examples, the reaction comprises combining a metal halide catalyst particle with an active-site reagent. In these reactions, the metal halide catalyst particle is modified by a substitution reaction that replaces the halo groups of the metal halide with active-site groups from the active-site reagent. In some examples, an oxidation reaction also changes the oxidation state of the first metal atom M¹ of the metal halide catalyst particle. For example, in the reaction of iridium(III) chloride with an active-site reagent, a chloro group is replaced with an active-site group and iridium(III) undergoes oxidation to iridium(IV). The reaction of the metal halide with the active-site reagent is carried out in the presence of water and oxygen (e.g., oxygen gas or air) and, in some examples, may be carried out in a one-pot process. The resulting catalyst particle may be a monomer molecule (e.g., with terminal hydroxyl groups) or may be part of a larger oligomeric or polymeric structure that is formed during the reaction.

A metal halide catalyst particle includes cations of one or more metals ionically bonded to halide anions, including fluoride (F⁻), chloride (Cl⁻), bromide (Br⁻), and iodide (I⁻) anions. Metal halides include single-metal halides and mixed-metal halides. A single-metal halides includes cations of a single metal in a single state of oxidation. Mixed-metal halides include cations of a metal and one or more other elements (e.g., another metal or a non-metal). Mixed-metal halides also encompass materials having cations of a single metal in several different states of oxidation. Illustrative examples of metal halides that may constitute the metal halide catalyst particle include, without limitation, platinum group metal chlorides (e.g., platinum(II) chloride (PtCl₂), platinum(IV) chloride (PtCl₄), palladium(II) chloride (PdCl₂), iridium(III) chloride (IrCl₃), ruthenium(III) chloride (RuCl₃)), transition metal chlorides (e.g., titanium(II) chloride (TiCl₂), titanium(III) chloride (TiCl₃), titanium(IV) chloride (TiCl₄), zirconium(IV) chloride (ZrCl₄), vanadium(II) chloride (VCl₂), vanadium(II) chloride (VCl₃), vanadium(IV) chloride (VCl₄), vanadium(V) chloride (VCl₅), chromium(II) chloride (CrCl₂), chromium(III) chloride (CrCl₃), a molybdenum chloride (MoClₓ), iron(II) chloride (FeCl₂), iron(III) chloride (FeCl₃), nickel(II) chloride (NiCl₂), copper(II) chloride (CuCl₂), zinc(II) chloride (ZnCl₂), cadmium(II) chloride (CdCl₂), cobalt(II) chloride (CoCl₂), gold(III) chloride (AuCl₃)), post-transition metal chlorides (e.g., gallium(II) chloride (GaCl₂), gallium(III) chloride (GaCl₃), indium(III) chloride (InCl₃), tin(II) chloride (SnCl₂), tin(IV) chloride (SnCl₄), bismuth(III) chloride (BiCl₃)), aluminum(II) trifluoride, aluminum chlorofluoride, cobalt(II) bromide, cobalt manganese bromide, rhodium iodide, ruthenium iodide, iridium iodide, and potassium iodide. In some examples, the metal halide is preferably a platinum group metal chloride (e.g., platinum(IV) chloride or iridium(III) chloride) or bismuth(III) chloride.

Illustrative examples of modified metal oxide catalysts and illustrative reaction schemes for synthesizing modified metal oxide catalysts will now be shown and described with reference to FIGS. 1A to 1C, FIGS. 2A to 2C, FIG. 3, and FIGS. 4A and 4B. The following examples are merely illustrative and are not limiting. In the following examples, a representative portion of an iridium(IV) oxide particle is shown. Iridium(IV) oxide has a rutile-like structure with the general formula (IrO₂)ₙ where iridium is hexa-coordinated. Iridium(IV) oxide may be hydroxylated to varying degrees at the surface. FIGS. 1A-1C, 2A-2C, and 3 show only two hexa-coordinated iridium atoms of an iridium(IV) oxide particle at or near the surface of the iridium(IV) oxide particle. It will be understood that iridium(IV) oxide includes other units (e.g., unit cells) and components (e.g., surface hydroxyl groups, defects, dopants, etc.) not shown in the figures.

FIGS. 1A to 1C show illustrative reaction schemes for producing a boronic group-modified iridium(IV) oxide catalyst. As shown in FIGS. 1A to 1C, a boronic group-modified iridium(IV) oxide catalyst is produced by combining iridium(IV) oxide and boric acid. Iridium(IV) oxide and boric acid may be combined in any suitable way, such as in a solvent (as described above) with mechanical agitation, by mechanochemical reaction (e.g., ball milling), and/or by ultrasonication.

In the example of FIG. 1A, the molar ratio of iridium(IV) oxide to boric acid is approximately 1:1. That is, one mol of boric acid is combined with one mol of iridium(IV) oxide particles. Alternatively, where the reaction is carried out by ball milling, the mol amount of boric acid is roughly equal to the mol amount of modified iridium(IV) oxide particles expected to be produced by the ball milling. The reaction mechanism of FIG. 1A is generally involves two hydroxyl groups of a boric acid molecule linking with an iridium atom at the surface of the iridium(IV) oxide particle, followed by a transfer of the protons of the hydroxyl groups to neighboring lattice oxygen atoms. Thus, in reaction product (a) the boron atom is linked to the iridium atom by two oxo-bridges.

In the example of FIG. 1B, the molar ratio of iridium(IV) oxide to boric acid is approximately 1:2. The reaction mechanism generally involves one or two hydroxyl groups of each boric acid molecule linking with an iridium atom, followed by transfer of the proton(s) of the hydroxyl group(s) to the neighboring lattice oxygen atom(s). With this reaction scheme, the boron atom is linked to the iridium atom by one or two oxo-bridges. As shown in FIG. 1B, various different reaction products may be produced. In reaction product (b), each boron atom is linked to an iridium atom by two oxo-bridges. In reaction product (c), one boron atom is linked to an iridium atom by one oxo-bridge and the other boron atom is linked to another iridium atom by two oxo-bridges. In reaction product (d), each boron atom is linked to an iridium atom by one oxo-bridge. In reaction product (e), each boron atom is linked to the same iridium atom by one oxo-bridge.

In the example of FIG. 1C, the molar ratio of iridium(IV) oxide to boric acid is 1:3. As in FIG. 1B, various different reaction products may be produced. In reaction product (f), two boron atoms are linked to an iridium atom by two oxo-bridges, and the third boron atom is linked to one of the iridium atoms by one oxo-bridge. In reaction product (g), two boron atoms are linked to the same iridium atom, each by one oxo-bridge, and the other boron atom is linked to another iridium atom by two oxo-bridges. In reaction product (h), two boron atoms are linked to the same iridium atom, each by one oxo-bridge, and the other boron atom is linked to another iridium atom by one oxo-bridge.

The reaction products (a)-(h) of FIGS. 1A to 1C are metallic complexes comprising boron linked with iridium(IV) by one or two oxo-bridges. It will be recognized that the reaction schemes shown in FIGS. 1A to 1C are merely illustrative, as various different configurations and combinations of oxo-bridges may be obtained. Furthermore, other molar ratios may be used to obtain a desired degree of modification of the iridium(IV) oxide surface. For example, the molar ratio of iridium(IV) oxide to boric acid may be based on a size or total surface area of the iridium(IV) oxide particles. For instance, the molar ratio of iridium(IV) oxide to boric acid may be set so that roughly 25%, 50%, 75%, or 100% of the surface of the iridium(IV) oxide particle is modified with boronic groups. Furthermore, other boronic compounds may be used in place of, or in addition to, boric acid, such as but not limited to a boronic acid, a boronic ester, or a mixture of diboron trioxide and water.

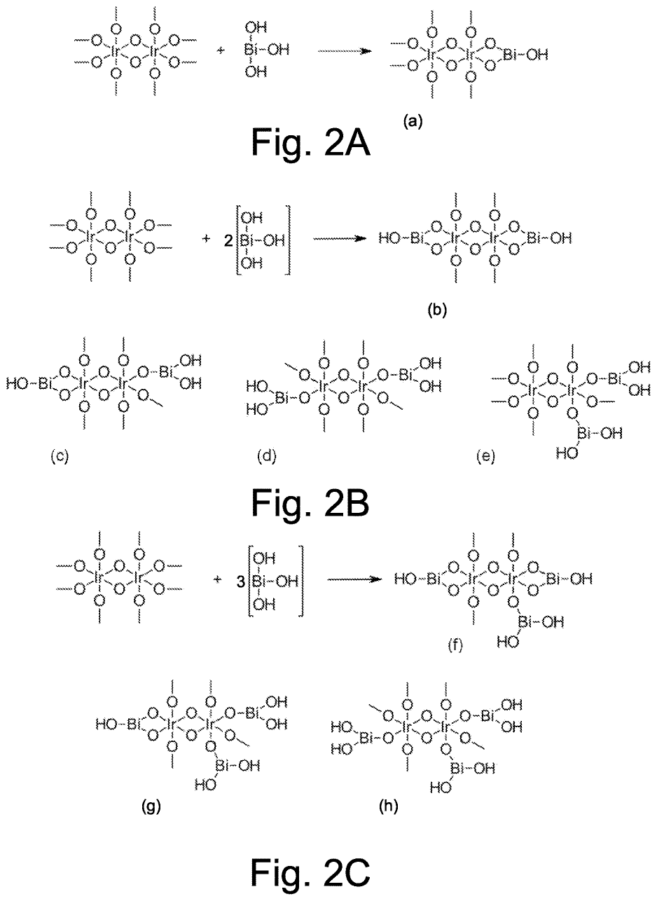

FIGS. 2A to 2C show illustrative reaction schemes for producing a bismuth hydroxide group-modified iridium(IV) oxide catalyst. FIGS. 2A to 2C are similar to FIGS. 1A to 1C except that, in FIGS. 2A to 2C, iridium(IV) oxide is combined with bismuth hydroxide (Bi(OH)₃) instead of with boric acid.

In the example of FIG. 2A, the molar ratio of iridium(IV) oxide to bismuth hydroxide is approximately 1:1. The reaction mechanism generally involve two hydroxyl groups of a bismuth hydroxide molecule linking with an iridium atom at the surface of the iridium(IV) oxide catalyst particle, followed by a transfer of the protons of the hydroxyl groups to neighboring lattice oxygen atoms. In reaction product (a), the bismuth atom is linked to the iridium atom by two oxo-bridges.

In the example of FIG. 2B, the molar ratio of iridium(IV) oxide to bismuth hydroxide is approximately 1:2. The reaction mechanism generally involves one or two hydroxyl groups of each bismuth hydroxide molecule linking with an iridium atom, followed by transfer of the proton(s) of the hydroxyl group(s) to the neighboring lattice oxygen atom(s). With this reaction scheme, the bismuth atom is linked to the iridium atom by one or two oxo-bridges. As shown in FIG. 2B, various different reaction products may be produced. In reaction product (b), each bismuth atom is linked to an iridium atom by two oxo-bridges. In reaction product (c), one bismuth atom is linked to an iridium atom by one oxo-bridge and the other bismuth atom is linked to another iridium atom by two oxo-bridges. In reaction product (d), each bismuth atom is linked to an iridium atom by one oxo-bridge. In reaction product (e), each bismuth atom is linked to the same iridium atom by one oxo-bridge.

In the example of FIG. 2C, the molar ratio of iridium(IV) oxide to bismuth hydroxide is 1:3. As in FIG. 2B, various different reaction products may be produced. In reaction product (f), two bismuth atoms are linked to an iridium atom by two oxo-bridges, and the third bismuth atom is linked to one of the iridium atoms by one oxo-bridge. In reaction product (g), two bismuth atoms are linked to the same iridium atom, each by one oxo-bridge, and the other bismuth atom is linked to another iridium atom by two oxo-bridges. In reaction product (h), two bismuth atoms are linked to the same iridium atom, each by one oxo-bridge, and the other bismuth atom is linked to another iridium atom by one oxo-bridge.

The reaction products (a)-(h) of FIGS. 2A to 2C are bi-metallic complexes comprising bismuth linked with iridium by one or two oxo-bridges. It will be recognized that the reaction schemes shown in FIGS. 2A to 2C are merely illustrative, as various different configurations and combinations of oxo-bridges may be obtained. Furthermore, other molar ratios may be used to obtain a desired degree of modification of the iridium(IV) oxide surface. For example, the molar ratio of iridium(IV) oxide to bismuth hydroxide may be tuned based on a size or total surface area of the iridium(IV) oxide particles and the desired degree of modification of the iridium(IV) oxide surface. For instance, the molar ratio of iridium(IV) oxide to boric acid may be set so that roughly 25%, 50%, 75%, or 100% of the surface of the iridium(IV) oxide particle is modified with bismuth hydroxide groups. Furthermore, other metal hydroxides and/or metal oxyhydroxides may be used in place of, or in addition to, bismuth hydroxide, such as but not limited to aluminum hydroxide, aluminum oxyhydroxide, gallium hydroxide, gallium oxyhydroxide, indium hydroxide, indium oxyhydroxide, and beryllium hydroxide.

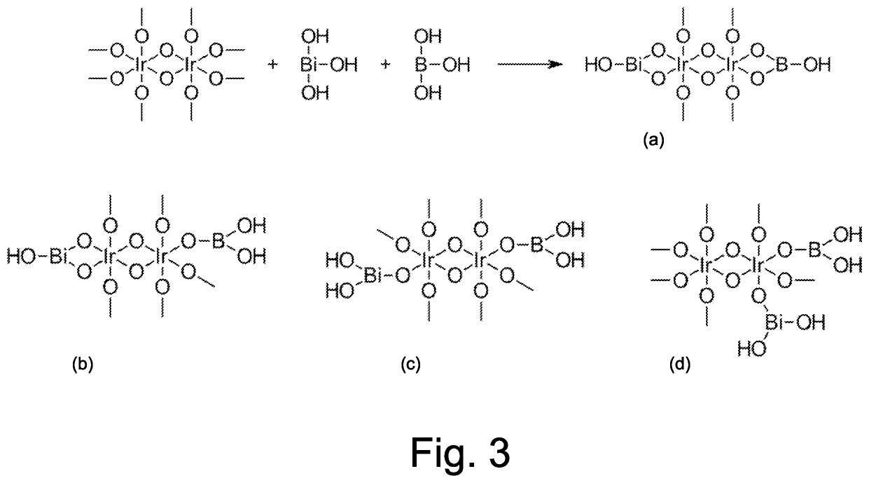

FIG. 3 shows another illustrative reaction scheme for producing an iridium(IV) oxide catalyst material modified with both boronic groups and bismuth hydroxide groups. As shown in FIG. 3, iridium(IV) oxide is combined with both boric acid and bismuth hydroxide. In the example of FIG. 3, the molar ratio of iridium(IV) oxide to boric acid and to bismuth hydroxide is 1:1:1. The reaction mechanism generally involves one or two hydroxyl groups of the boric acid and one or two hydroxyl groups of bismuth hydroxide linking with iridium atoms at the surface of the iridium(IV) oxide catalyst particle, followed by transfer of the protons of the hydroxyl groups to neighboring lattice oxygen atoms. With this reaction scheme, the boron atom and the bismuth atom are linked to iridium atoms by one or two oxo-bridges. As shown in FIG. 3, various different reaction products may be obtained. In reaction product (a), the boron atom and the bismuth atom are each linked to an iridium atom by two oxo-bridges. In reaction product (b), the boron atom is linked to an iridium atom by one oxo-bridge and the bismuth atom is linked to an iridium atom by two oxo-bridges. In reaction product (c), both the boron atom and the bismuth atom are linked to iridium atoms by one oxo-bridge. In reaction product (d), both the boron atom and the bismuth atoms are linked to the same iridium atom by one oxo-bridge.

It will be recognized that the reaction scheme shown in FIG. 3 is merely illustrative, as various different configurations and combinations of oxo-bridges may be obtained. Furthermore, other molar ratios may be used for desired catalyst performances while minimizing iridium loading. For example, the molar ratio of iridium(IV) oxide to boric acid and to bismuth hydroxide may be tuned based on a size or total surface area of the iridium(IV) oxide particles to obtain a desired degree of modification of the iridium(IV) oxide surface. For instance, the molar ratio of iridium(IV) oxide to boric acid and to bismuth hydroxide may be set so that roughly 25%, 50%, 75%, or 100% of the surface of the iridium(IV) oxide particle is modified with boronic groups and/or bismuth hydroxide groups. Furthermore, other boronic compounds may be used in place of, or in addition to, boric acid, including any compounds described herein. Moreover, other metal hydroxides and/or metal oxyhydroxides may be used in place of, or in addition to, bismuth hydroxide, including any metal hydroxides and/or metal oxyhydroxides described herein. Furthermore, in the examples of FIGS. 1A to 3 described above, boric acid and/or bismuth hydroxide is combined with iridium(IV) oxide (or composite materials including iridium(IV) oxide). However, it will be recognized that boric acid and/or bismuth hydroxide (or other active-site reagents) may be combined in a like or similar manner with other metal oxides or metal oxide composites, including but not limited to any catalyst materials and/or composites comprising one or more platinum group metals, transition metals, and/or post-transition metals.

FIGS. 4A and 4B show illustrative reaction schemes for producing a non-PGM catalyst based on a bismuth(III) oxide (Bi₂O₃) catalyst particle. As shown, bismuth(III) oxide and boric acid are combined to produce a boronic-group modified bismuth(III) oxide catalyst. Bismuth(III) oxide and boric acid may be combined in any suitable way, such as in a solvent (as described above), with mechanical agitation, by mechanochemical reaction (e.g., ball milling), and/or by ultrasonication.

In the example of FIG. 4A, the molar ratio of bismuth(II) oxide to boric acid is approximately 1:2. A hydroxyl group from each of two boric acid molecules bonds with a bismuth atom of bismuth(III) oxide in a dehydration reaction. In the reaction product, the boron atoms are oxo-bridged with the same bismuth atom. Thus, the bismuth(III) oxide is modified with two boronic groups. In the example of FIG. 4B, the molar ratio of bismuth(III) oxide to boric acid is 1:4. The reaction is similar to the reaction of FIG. 4A except that, in the reaction of FIG. 4B, boric acid combines with both bismuth atoms of the bismuth(III) oxide. Thus, the bismuth(III) oxide is modified with four boronic groups.

It will be recognized that the reaction schemes shown in FIGS. 4A and 4B are merely illustrative, as various modifications may be made to the reaction schemes. For example, other boronic compounds may be used in place of boric acid, including any suitable compounds described herein. Furthermore, one or more metal hydroxides and/or metal oxyhydroxides may be used in place of, or in addition to, boric acid, including any metal hydroxides and/or metal oxyhydroxides described herein. Moreover, other metal oxide catalyst particles may be used in place of, or in addition to, bismuth(III) oxide, such as but not limited to gallium(III) oxide (Ga₂O₃), indium(III) oxide (In₂O₃), and/or composites thereof.

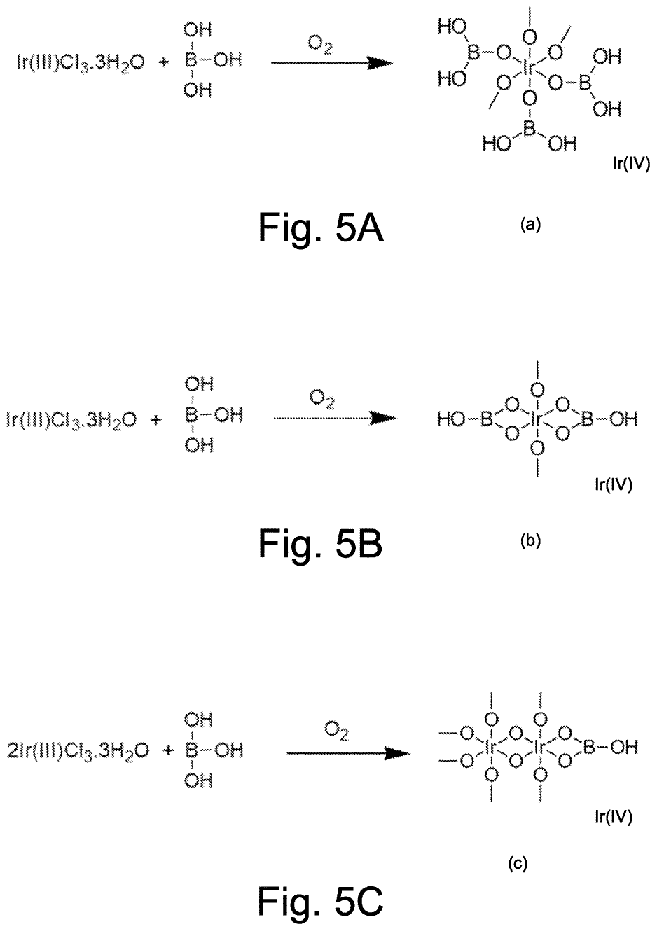

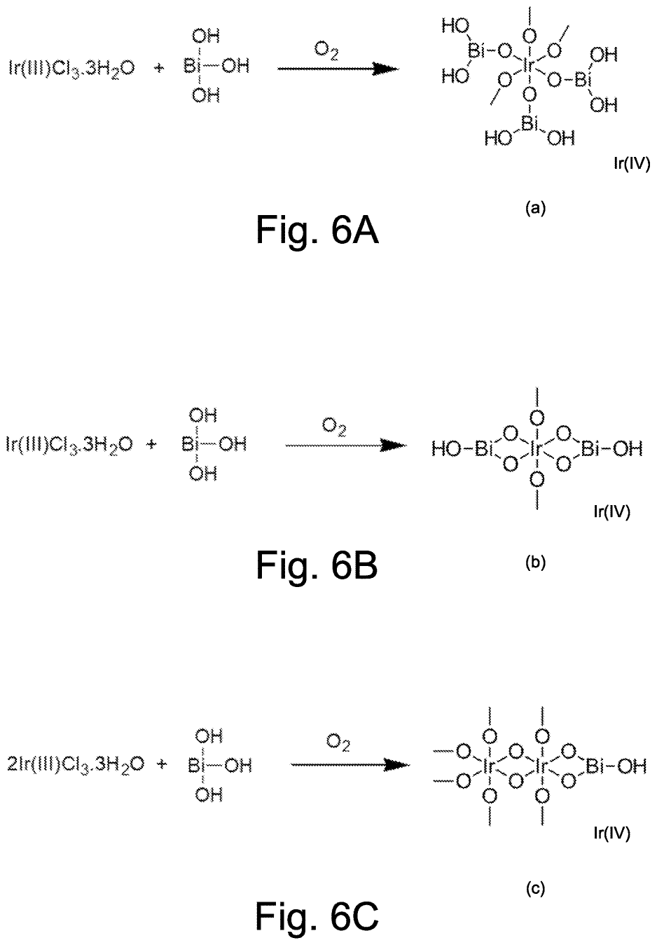

Illustrative examples of reaction schemes for synthesizing modified catalysts using iridium(III) chloride (IrCl₃) catalyst particles will now be shown and described with reference to FIGS. 5A to 5C and FIGS. 6A to 6C. The following examples are merely illustrative and are not limiting.

As shown in FIGS. 5A to 5C, a boronic group-modified iridium(IV) catalyst particle is produced by combining iridium(III) chloride trihydrate and boric acid in the presence of oxygen. Iridium(III) chloride trihydrate and boric acid may be combined in any suitable way, such as in a solvent (as described above) with mechanical agitation, by mechanochemical reaction (e.g., ball milling), and/or by ultrasonication.

In the example of FIG. 5A, the molar ratio of iridium(III) chloride trihydrate to boric acid is approximately 1:3. The reaction mechanism of FIG. 5A is a substitution reaction involving hydroxyl groups of three boric acid molecules and the chloro groups of an iridium(III) chloride molecule. Reaction product (a) includes three boronic groups oxo-bridged with one iridium atom. The three boron atoms are each linked to the iridium atom by one oxo-bridge, and iridium has increased its oxidation state from +3 to +4. The resulting boronic group-modified catalyst particle is a hexacoordinated iridium(IV) complex.

The reaction scheme of FIG. 5B is similar to the reaction scheme of FIG. 5A except that, as shown in FIG. 5B, reaction product (b) includes two boronic groups oxo-bridged with one iridium atom. The two boron atoms are each linked to the iridium atom by two oxo-bridges, and iridium has increased its oxidation state from +3 to +4. The resulting boronic group-modified catalyst particle is a hexacoordinated iridium(IV) complex.

In the example of FIG. 5C, the molar ratio of iridium(III) chloride trihydrate to boric acid is approximately 2:1. Reaction product (c) includes two iridium centers and one boronic group oxo-bridged with one of the iridium centers. The boron atom is linked to the iridium center by two oxo-bridges, and iridium has increased its oxidation state from +3 to +4. The resulting boronic group-modified catalyst particle is a hexacoordinated iridium(IV) complex.

Reaction products (a) to (c) shown in FIGS. 5A to 5C are hexacoordinated complexes comprising boron atoms linked with iridium centers by one or two oxo-bridges. Reaction products (a) to (c) shown in FIGS. 5A to 5C may be part of groups of molecules, such as in oligomers molecules or polymer molecules in which repeat units are linked by oxygen ligands. For example, the reactions may induce oligomerization and/or polymerization of boronic-group modified catalyst particles. In other examples, reaction products (a) to (c) are single molecule (e.g., monomeric) complexes in which the oxygen ligands are part of terminal hydroxyl groups. Reaction products (a) to (c) may be fashioned into any suitable shape or structure, such as nanoparticles, nanotubes, thin films, etc. It will be recognized that the reaction schemes shown in FIGS. 5A to 5C are merely illustrative, as various different compositions of boronic groups and oxo-bridges may be obtained depending on the stoichiometry of iridium(III) chloride and boric acid. For example, other molar ratios may be used to obtain a desired composition of boronic group-modified iridium(IV) catalyst particles. Furthermore, other metal halides may be used in place of iridium(III) chloride and other active-site reagents may be used in place of boric acid.

For example, as shown in FIGS. 6A to 6C, a bismuth hydroxide-modified iridium(IV) catalyst particle is produced by combining iridium(III) chloride trihydrate and bismuth hydroxide in the presence of oxygen. Iridium(III) chloride trihydrate and bismuth hydroxide may be combined in any suitable way, such as in a solvent (as described above) with mechanical agitation, by mechanochemical reaction (e.g., ball milling), and/or by ultrasonication.

In the example of FIG. 6A, the molar ratio of iridium(III) chloride trihydrate to bismuth hydroxide is approximately 1:3. The reaction mechanism of FIG. 6A includes a substitution reaction involving hydroxyl groups of three bismuth hydroxide molecules and the chloro groups of an iridium(III) chloride molecule and oxidation of iridium(III). Reaction product (a) includes three bismuth hydroxide groups oxo-bridged with one iridium atom. The three boron atoms are each linked to the iridium atom by one oxo-bridge, and iridium has increased its oxidation state from +3 to +4. The resulting bismuth hydroxide group-modified catalyst particle is a hexacoordinated iridium(IV) complex.

The reaction scheme of FIG. 6B is similar to the reaction scheme of FIG. 6A except that, as shown in FIG. 6B, reaction product (b) includes two bismuth hydroxide groups oxo-bridged with one iridium atom. The two boron atoms are each linked to the iridium atom by two oxo-bridges, and iridium has increased its oxidation state from +3 to +4. The resulting bismuth hydroxide group-modified catalyst particle is a hexacoordinated iridium(IV) complex.

In the example of FIG. 6C, the molar ratio of iridium(III) chloride trihydrate to bismuth hydroxide is approximately 2:1. Reaction product (c) includes two iridium(IV) centers and one bismuth hydroxide group oxo-bridged with one of the iridium(IV) centers. The boron atom is linked to the iridium(IV) center by two oxo-bridges, and iridium has increased its oxidation state from +3 to +4. The resulting bismuth hydroxide group-modified catalyst particle is a hexacoordinated iridium(IV) complex.

Reaction products (a) to (c) shown in FIGS. 6A to 6C are hexacoordinated complexes comprising bismuth atoms linked with iridium centers by one or two oxo-bridges. Reaction products (a) to (c) shown in FIGS. 6A to 6C may be part of groups of molecules, such as in oligomers or polymers in which repeat units are linked by oxygen ligands. For example, the reactions may induce oligomerization and/or polymerization of bismuth hydroxide group-modified catalyst particles. In other examples, reaction products (a) to (c) are single molecule (e.g., monomeric) complexes in which the oxygen ligands are part of terminal hydroxyl groups. Reaction products (a) to (c) may be fashioned into any suitable shape or structure, such as nanoparticles, nanotubes, thin films, etc. It will be recognized that the reaction schemes shown in FIGS. 6A to 6C are merely illustrative, as various different compositions of bismuth hydroxide groups and oxo-bridges may be obtained depending on the stoichiometry of iridium(III) chloride and bismuth hydroxide. For example, other molar ratios may be used to obtain a desired composition of bismuth hydroxide group-modified iridium(IV) catalyst particles. Furthermore, other metal halides may be used in place of iridium(III) chloride and other active-site reagents may be used in place of bismuth hydroxide.

In the examples of FIGS. 5A to 6C, iridium(III) chloride is combined with only type of active-site reagent. In other examples, iridium(III) chloride (or any other metal halide) may be combined with two or more different active-site reagents.

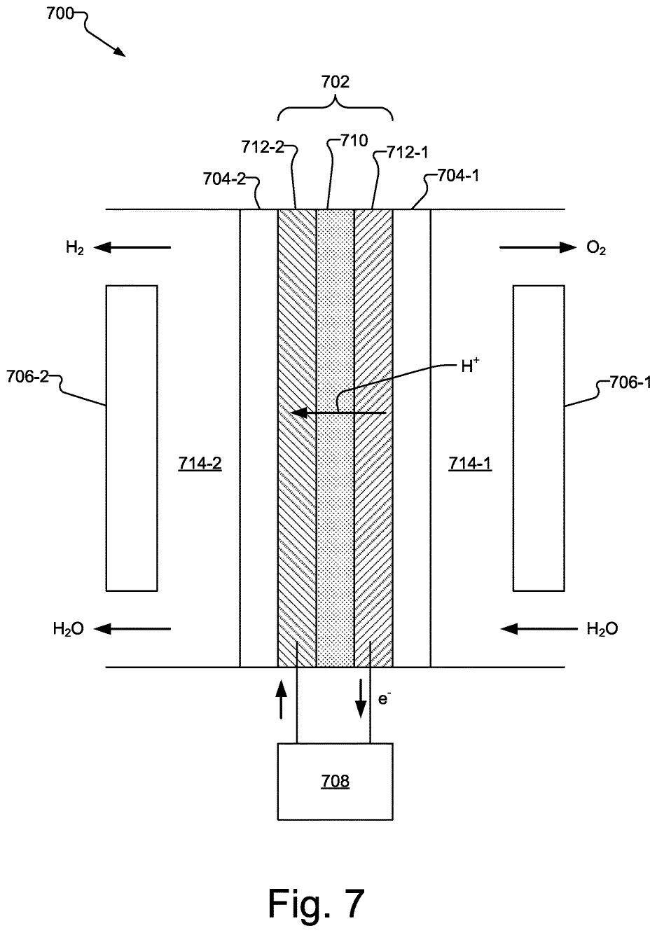

The catalysts described herein may be used in various electrochemical cells, such as, but not limited to, water electrolysis systems and fuel cells. FIG. 7 shows an illustrative proton exchange membrane water electrolysis system 700 (PEM water electrolysis system 700). PEM water electrolysis system 700 uses electricity to split water into oxygen (O₂) and hydrogen (H₂) via an electrochemical reaction. The configuration of PEM water electrolysis system 700 is merely illustrative and not limiting, as other suitable configurations as well as other suitable water electrolysis systems may incorporate a boron-containing porous membrane.

As shown in FIG. 7, PEM water electrolysis system 700 includes a membrane electrode assembly 702 (MEA 702), porous transport layers 704-1 and 704-2, bipolar plates 706-1 and 706-2, and an electrical power supply 708. PEM water electrolysis system 700 may also include additional or alternative components not shown in FIG. 7 as may serve a particular implementation.

MEA 702 includes a PEM 710 positioned between a first catalyst layer 712-1 and a second catalyst layer 712-2. PEM 710 electrically isolates first catalyst layer 712-1 from second catalyst layer 712-2 while providing selective conductivity of cations, such as protons (H⁺), and while being impermeable to gases such as hydrogen and oxygen. PEM 710 may be implemented by any suitable organic or inorganic PEM. Illustrative examples of organic PEMs include, without limitation, synthetic polymers and natural polymers. Examples of synthetic polymers include sulfonic acid-functionalized polymers such as Nafion® (available from E.I. Dupont de Nemours and Company in various configurations and grades, including Nafion-H, Nafion HP Nafion 117, Nafion 115, Nafion 212, Nafion 211, Nafion NE1035, Nafion XL, etc.), Aquivion® (available from Solvay S.A. in different configurations and grades, including Aquivion® E98-05, Aquivion® PW98, Aquivion® PW87S, etc.), Gore-Select® (available from W.L. Gore & Associates, Inc.), Flemion™ (available from Asahi Glass Company), Pemion+™ (available from Ionomer Innovations, Inc.), and any combination, derivative, grade, or configuration thereof. Examples of natural polymers include, without limitation, lignin, cellulose, or chitin. Examples of inorganic PEMs include, without limitation, amorphous inorganic materials (e.g., glass, fused silica, or ceramics) and/or crystalline inorganic materials (e.g., quartz, single crystal silicon, or alumina).

First catalyst layer 712-1 and second catalyst layer 712-2 are electrically conductive electrodes with embedded electrochemical catalyst particles (not shown) as described herein. For example, the electrochemical catalyst particles of first catalyst layer 712-1 and/or second catalyst layer 712-2 may include any of the modified catalysts described herein. In some examples, the modified catalysts are supported on an ion exchange-functionalized catalyst support, such as any ion exchange-functionalized catalyst support described in International Patent Application No. PCT/US2022/046105.

In some examples, first catalyst layer 712-1 and/or second catalyst layer 712-2 includes a supported catalyst mixed with an ionomer (an ion-conducting polymer). The ionomer binds the catalysts within the electrode, binds the catalyst layer on the PEM, and provides a pathway for cations (e.g., protons), thereby improving cation conductivity. The ionomer used in first catalyst layer 712-1 and second catalyst layer 712-2 may include any suitable ionomer, including any ionomer described herein.

MEA 702 is placed between porous transport layers 704-1 and 704-2, which are in turn placed between bipolar plates 706-1 and 706-2 with flow channels 714-1 and 714-2 located in between bipolar plates 706 and porous transport layers 704.

In MEA 702, first catalyst layer 712-1 functions as an anode and second catalyst layer 712-2 functions as a cathode. When PEM water electrolysis system 700 is powered by power supply 708, the oxygen evolution reaction (OER) occurs at anode 712-1, represented by the electrochemical half-reaction of equation (1):

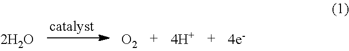

Protons are conducted from anode 712-1 to cathode 712-2 through PEM 710, and electrons are conducted from anode 712-1 to cathode 712-2 by conductive path around PEM 710. PEM 710 allows for the transport of protons (H⁺) and water from the anode 712-1 to the cathode 712-2 but is impermeable to oxygen and hydrogen. At cathode 712-2, the protons combine with the electrons in a hydrogen evolution reaction (HER), represented by the following electrochemical half-reaction (reaction equation (2)):

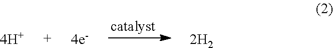

The OER and HER are two complementary electrochemical reactions for splitting water by electrolysis, represented by the following overall water electrolysis reaction (reaction equation (3)):

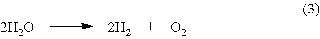

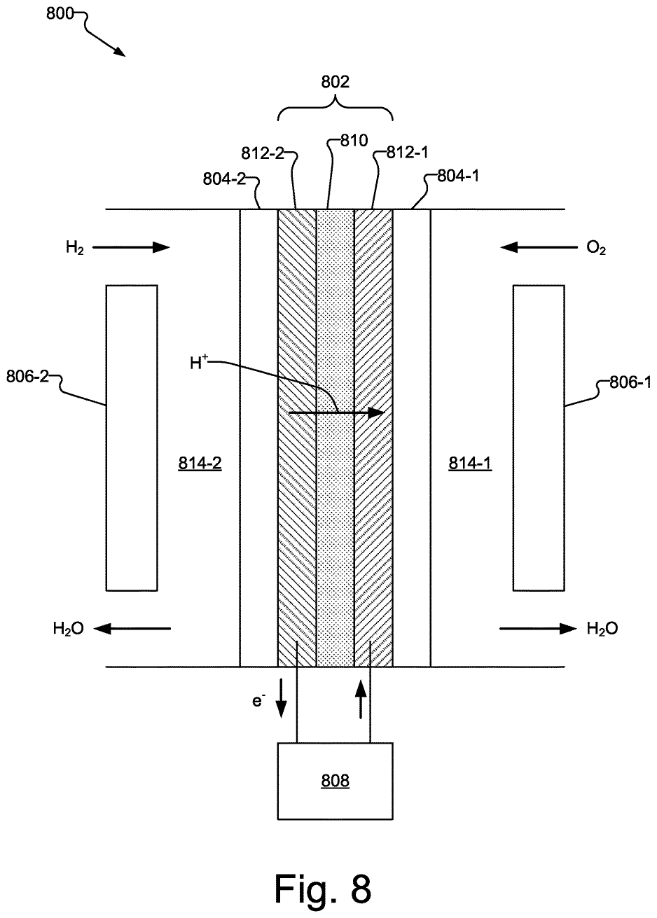

FIG. 8 shows an illustrative proton exchange membrane fuel cell 800 (PEM fuel cell 800). PEM fuel cell 800 produces electricity as a result of electrochemical reactions. In this example, the electrochemical reactions involve reacting hydrogen gas (H₂) and oxygen gas (O₂) to produce water and electricity. The configuration of PEM fuel cell 800 is merely illustrative and not limiting, as other suitable configurations as well as other suitable proton exchange membrane fuel cells may incorporate a boron-containing porous membrane.

As shown in FIG. 8, PEM fuel cell 800 includes a membrane electrode assembly 802 (MEA 802), porous transport layers 804-1 and 804-2, bipolar plates 806-1 and 806-2. An electrical load 808 may be electrically connected to MEA 802 and driven by PEM fuel cell 800. PEM fuel cell 800 may also include additional or alternative components not shown in FIG. 8 as may serve a particular implementation.

MEA 802 includes a PEM 810 positioned between a first catalyst layer 812-1 and a second catalyst layer 812-2. PEM 810 electrically isolates first catalyst layer 812-1 from second catalyst layer 812-2 while providing selective conductivity of cations, such as protons (H⁺), and while being impermeable to gases such as hydrogen and oxygen. PEM 810 may be implemented by any suitable PEM, including any PEM described herein.

First catalyst layer 812-1 and second catalyst layer 812-2 are electrically conductive electrodes with embedded electrochemical catalysts (not shown).

For example, the electrochemical catalyst particles of first catalyst layer 812-1 and/or second catalyst layer 812-2 may include any of the modified catalysts described herein. In some examples, the modified catalysts are supported on an ion exchange-functionalized catalyst support, such as any ion exchange-functionalized catalyst support described herein.

In some examples, first catalyst layer 812-1 and/or second catalyst layer 812-2 includes a supported catalyst mixed with an ionomer (an ion-conducting polymer). The ionomer binds the catalysts within the electrode, binds the catalyst layer on the PEM, and provides a pathway for cations (e.g., protons), thereby improving cation conductivity. The ionomer used in first catalyst layer 812-1 and second catalyst layer 812-2 may include any suitable ionomer, including any ionomer described herein.

MEA 802 is placed between porous transport layers 804-1 and 804-2, which are in turn placed between bipolar plates 806-1 and 806-2 with flow channels 814 located in between. In MEA 802, first catalyst layer 812-1 functions as a cathode and second catalyst layer 812-2 functions as an anode. Cathode 812-1 and anode 812-2 are electrically connected to load 808, and electricity generated by PEM fuel cell 800 drives load 808.

During operation of PEM fuel cell 800, hydrogen gas (H₂) flows into the anode side of PEM fuel cell 800 and oxygen gas (O₂) flows into the cathode side of PEM fuel cell 800. At anode 812-2, hydrogen molecules are catalytically split into protons (H⁺) and electrons (e⁻) according to the following hydrogen oxidation reaction (HOR) (reaction equation (4)):

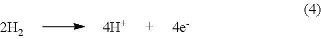

The protons are conducted from anode 812-2 to cathode 812-1 through PEM 810, and the electrons are conducted from anode 812-2 to cathode 812-1 around PEM 810 through a conductive path and load 808. At cathode 812-1, the protons and electrons combine with the oxygen gas according to the following oxygen reduction reaction (ORR) (reaction equation (5)):

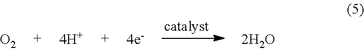

Thus, the overall electrochemical reaction for the PEM fuel cell 800 is given by reaction equation (6):

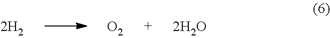

In the overall reaction, PEM fuel cell 800 produces water at cathode 812-1. Water may flow from cathode 812-1 to anode 812-2 through PEM 810 and may be removed through outlets at the cathode side and/or anode side of PEM fuel cell 800. The overall reaction generates electrons at the anode that drive load 808.

In some examples, one or more of the ionomers, membranes, and PEMs of system 700 or system 800 may be implemented by an ionomer, membrane, and/or PEM described in International Patent Application No. PCT/US2021/029705, filed Apr. 28, 2021; International Patent Application No. PCT/US2021/038956, filed Jun. 24, 2021; International Patent Application No. PCT/US2022/039845, filed Aug. 9, 2022; International Patent Application No. PCT/US2022/043878, filed Sep. 16, 2022, and U.S. Provisional Patent Application No. 63/302,755, filed Jan. 25, 2022, each of which is incorporated herein in its entirety.

As mentioned, the modified catalysts described herein may be used in other applications besides water electrolysis and hydrogen fuel cell applications. In some examples, the modified catalysts described herein are used in the Haber-Bosh process for the synthesis of ammonia. The Haber-Bosch process converts atmospheric nitrogen (N₂) to ammonia (NH₃) by a reaction with hydrogen (H₂) using a metal catalyst under high temperatures and pressures. The Haber-Bosch process is given by the following reaction equation (7):

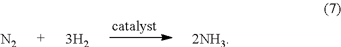

The catalyst accelerates breaking of the triple bonds of atmospheric nitrogen. Conventional catalysts used in the Haber-Bosch process generally include iron-based catalysts such as ferrite (α-Fe), iron oxides (e.g., magnetite (Fe₃O₄), wustite (FeO)), and/or supported iron (e.g., iron supported on an iron oxide, optionally with promoters). However, iron-based catalysts have various drawbacks, including high pressures and temperatures necessary for efficient catalytic activity (e.g., 400 to 550° C.) and complex processes for production of iron-based catalysts. Additionally, hydrogen gas (H₂) often reduces iron oxide to metallic iron, thus degrading performance of the catalyst.

In some examples, the Haber-Bosch process (e.g., reaction equation (7)) is performed using a modified catalyst, as described herein. Any modified catalyst described herein may be used. In some examples, the modified catalyst for the Haber-Bosch process includes iron oxide (e.g., magnetite or wustite) modified with a boronic group or a metal hydroxide/oxide group at a surface of the iron oxide. The modified iron oxide catalyst may be produced in any suitable way, including using any of the reaction schemes of FIGS. 1A to 3 but using a Haber-Bosch metal oxide (e.g., iron oxide) in place of iridium(IV) oxide. The boronic groups and/or metal hydroxide/oxide groups of the modified Haber-Bosch catalyst help stabilize the catalyst in the presence of hydrogen and further lower the activation energy of the chemical processes involved in this transformation, thereby enabling the Haber-Bosch process to be carried out at lower temperatures and pressures as compared with conventional Haber-Bosch catalysts.

It will be recognized that the modified catalysts described herein may be used in various other applications not explicitly described herein, such as in alkaline anion exchange membrane (AEM) fuel cells, AEM water electrolysis systems, electrochemical reduction of carbon dioxide (CO₂) (e.g., for the production of carbon monoxide, methanol, formic acid, methane, ethylene, ethanol, etc.), other electrochemical reduction reactions, synthesis of organic compounds, and polymerization reactions.

In the preceding description, various examples have been described with reference to the accompanying drawings. It will, however, be evident that various modifications and changes may be made thereto, and additional embodiments may be implemented, without departing from the scope of the claims that follow. For example, certain features of one embodiment described herein may be combined with or substituted for features of another embodiment described herein. The description and drawings are accordingly to be regarded in an illustrative rather than a restrictive sense.

Advantages and features of the present disclosure can be further described by the following examples:
Example 1. A catalyst comprising: a catalyst particle comprising a first metal atom and an active-site group linked to the first metal atom by one or more oxo-bridges, wherein: the active-site group comprises a boronic group, a metal hydroxide group, or a metal oxide group; the metal hydroxide group comprises a second metal atom or beryllium; the metal oxide group comprises the second metal atom; and the second metal atom is different from the first metal atom and comprises aluminum, gallium, indium, or bismuth.
Example 2. The catalyst of example 1, wherein the first metal atom comprises a platinum group metal.
Example 3. The catalyst of any of the preceding examples, wherein the first metal atom comprises bismuth.
Example 4. The catalyst of any of the preceding examples, wherein the first metal atom comprises nickel, cobalt, or iron.
Example 5. The catalyst of any of the preceding examples, wherein: the active-site group comprises the boronic group; and the boronic group comprises a trivalent boron atom linked with the first metal atom by the one or more oxo-bridges.
Example 6. The catalyst of any of the preceding examples, wherein: the active-site group comprises the boronic group; and the boronic group has the formula (Ia) or (Ib):

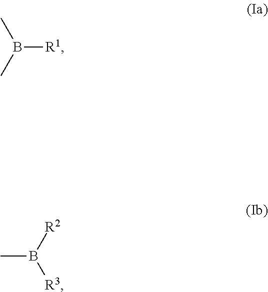

wherein R¹, R², and R³ are the same or different and each is independently a hydroxyl group (OH), an alkyl group, an aryl group, an alkoxy group, or an aryloxy group.
Example 7. The catalyst of example 6, wherein R¹ and at least one of R² or R³ is an alkoxy group having the general formula —O—R⁴ wherein the O is bonded to the boron atom of (Ia) or (Ib) and R⁴ is an alkyl group.
Example 8. The catalyst of any of examples 1-4, wherein the active-site group comprises a bismuth hydroxide group or a bismuth oxide group.
Example 9. A catalyst comprising: a first metal atom; and an active-site group comprising a boron atom or a second metal atom, wherein: the boron atom or the second metal atom is linked to the first metal atom by one or more oxo-bridges; and the second metal atom is different from the first metal atom and comprises aluminum, gallium, indium, bismuth, or beryllium.
Example 10. The catalyst of example 9, wherein the first metal atom comprises a platinum group metal.
Example 11. A method of making a catalyst, comprising: modifying a catalyst particle comprising a first metal atom with an active site group, wherein: the active-site group comprises a boronic group, a metal hydroxide group, or a metal oxide group; the metal hydroxide group comprises a second metal atom or beryllium; the metal oxide group comprises the second metal atom; and the second metal atom is different from the first metal atom and comprises aluminum, gallium, indium, or bismuth.
Example 12. The method of example 11, wherein the catalyst particle comprises a metal oxide.
Example 13. The method of example 12, wherein the metal oxide comprises an oxide of a platinum group metal.
Example 14. The method of example 12, wherein the metal oxide comprises iridium(IV) oxide or ruthenium(IV) oxide.
Example 15 The method of example 12, wherein the metal oxide comprises platinum(IV) oxide.
Example 16. The method of example 12, wherein the metal oxide comprises bismuth(III) oxide.
Example 17. The method of any of examples 11-16, wherein the catalyst particle comprises a metal halide.
Example 18. The method of example 17, wherein the metal halide comprises a platinum group metal.
Example 19. The method of example 17, wherein the metal halide comprises platinum(IV) chloride or iridium(III) chloride.
Example 20. The method of example 17, wherein the metal halide comprises bismuth(III) chloride.
Example 21. The method of any of examples 11-20, wherein the catalyst particle comprises an iron oxide.
Example 22. The method of any of examples 11-21, wherein the modifying the catalyst particle with the active site group comprises combining the catalyst particle with a boronic compound.
Example 23. The method of example 22, wherein the boronic compound comprises boric acid.
Example 24. The method of example 22, wherein the boronic compound comprises a boronic acid.
Example 25. The method of example 22, wherein the boronic compound comprises a boronic ester.
Example 26. The method of any of examples 11-21, wherein the modifying the catalyst particle with the active site group comprises combining the catalyst particle with diboron trioxide and water.
Example 27. The method of any of examples 11-21, wherein the modifying the catalyst particle with the active site group comprises combining the catalyst particle with a metal hydroxide, wherein the metal hydroxide comprises the second metal atom or beryllium.
Example 28. The method of any of examples 11-21, wherein the modifying the catalyst particle with the active site group comprises combining the catalyst particle with a metal oxyhydroxide comprising the second metal atom.
Example 29. A method comprising: carrying out the oxygen evolution reaction (OER) represented by the following electrochemical half-reaction of reaction equation (1) using the catalyst of any of examples 1-10:

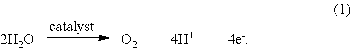

Example 30. A method comprising: carrying out the oxygen reduction reaction (ORR) represented by the electrochemical half-reaction of reaction equation (2) using the catalyst of any of examples 1-10:

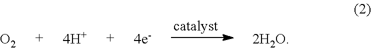

Example 31. A catalyst layer comprising: a catalyst support; the catalyst of any of examples 1-10; and an ionomer.
Example 32. A membrane electrode assembly, comprising: a cathode; an anode; and a proton exchange membrane positioned between the cathode and the anode; wherein at least one of the cathode or the anode comprises a catalyst layer comprising: a catalyst support; and the catalyst of any of examples 1-10.
Example 33. The membrane electrode assembly of example 32, wherein the catalyst layer further comprises an ionomer.
Example 34. A method of producing ammonia, comprising: combining nitrogen and hydrogen according to reaction equation (3) using the catalyst of any of examples 1-10:

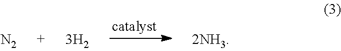

Example 35. The method of example 34, wherein the catalyst comprises a catalyst particle comprising iron oxide and the first metal atom comprises iron.

1. A catalyst comprising:
a catalyst particle comprising a first metal atom and an active-site group linked to the first metal atom by one or more oxo-bridges,
wherein:
the active-site group comprises a boronic group, a metal hydroxide group, or a metal oxide group;
the metal hydroxide group comprises a second metal atom or beryllium;
the metal oxide group comprises the second metal atom; and
the second metal atom is different from the first metal atom and comprises aluminum, gallium, indium, or bismuth.

2. The catalyst of claim 1, wherein the first metal atom comprises a platinum group metal.

3. The catalyst of claim 1, wherein the first metal atom comprises bismuth.

4. The catalyst of claim 1, wherein the first metal atom comprises nickel, cobalt, or iron.

5. The catalyst of claim 1, wherein:
the active-site group comprises the boronic group; and
the boronic group comprises a trivalent boron atom linked with the first metal atom by the one or more oxo-bridges.

6. The catalyst of claim 1, wherein:
the active-site group comprises the boronic group; and
the boronic group has the formula (Ia) or (Ib): 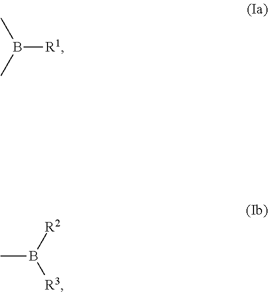
wherein R¹, R², and R³ are the same or different and each is independently a hydroxyl group (OH), an alkyl group, an aryl group, an alkoxy group, or an aryloxy group.

7. The catalyst of claim 6, wherein R¹ and at least one of R² or R³ is an alkoxy group having the general formula —O—R⁴ wherein the O is bonded to the boron atom of (Ia) or (Ib) and R⁴ is an alkyl group.

8. The catalyst of claim 1, wherein the active-site group comprises a bismuth hydroxide group or a bismuth oxide group.

9. A catalyst comprising:
a first metal atom; and
an active-site group comprising a boron atom or a second metal atom, wherein:
the boron atom or the second metal atom is linked to the first metal atom by one or more oxo-bridges; and
the second metal atom is different from the first metal atom and comprises aluminum, gallium, indium, bismuth, or beryllium.

10. The catalyst of claim 9, wherein the first metal atom comprises a platinum group metal.

11. A method of making a catalyst, comprising:
modifying a catalyst particle comprising a first metal atom with an active site group, wherein:
the active-site group comprises a boronic group, a metal hydroxide group, or a metal oxide group;
the metal hydroxide group comprises a second metal atom or beryllium;
the metal oxide group comprises the second metal atom; and
the second metal atom is different from the first metal atom and comprises aluminum, gallium, indium, or bismuth.

12. The method of claim 11, wherein the catalyst particle comprises a metal oxide.

13-15. (canceled)

16. The method of claim 12, wherein the metal oxide comprises bismuth(III) oxide.

17. The method of claim 11, wherein the catalyst particle comprises a metal halide.

18-19. (canceled)

20. The method of claim 17, wherein the metal halide comprises bismuth(III) chloride.

21. The method of claim 11, wherein the catalyst particle comprises an iron oxide.

22. The method of claim 11, wherein the modifying the catalyst particle with the active site group comprises combining the catalyst particle with a boronic compound, and the boronic compound comprises boric acid, a boronic acid, or a boronic ester.

23-25. (canceled)

26. The method of claim 11, wherein the modifying the catalyst particle with the active site group comprises combining the catalyst particle with diboron trioxide and water.

27. The method of claim 11, wherein the modifying the catalyst particle with the active site group comprises combining the catalyst particle with a metal hydroxide, wherein the metal hydroxide comprises the second metal atom or beryllium.

28. The method of claim 11, wherein the modifying the catalyst particle with the active site group comprises combining the catalyst particle with a metal oxyhydroxide comprising the second metal atom.

29-35. (canceled)
